(19) United States
(12) Patent Application Publication
(10) Pub. No.: US 2026/0357955 A1
(43) Pub. Date: Nov. 12, 2026

(54) LIGHTING ARRANGEMENT WITH RELEASABLY CONNECTABLE REFLECTOR

(71) Applicant: SIGNIFY HOLDING B.V., EINDHOVEN (NL)

(72) Inventors: JOHANNES PETRUS MARIA ANSEMS, HULSEL (NL); MICHAL JAN HORACZEK, BEST (NL); JAN DE GRAAF, UDEN (NL); TIES VAN BOMMEL, HORST (NL); SHANSHAN QU, SHANGHAI (CN)

(21) Appl. No.: 19/102,959

(22) PCT Filed: Aug. 4, 2023
(86) PCT No.: PCT/EP2023/071631

§ 371 Date: Feb. 11, 2025

(30) Foreign Application Priority Data
Aug. 11, 2022 (WO) PCT/CN2022/111874
Sep. 27, 2022 (EP) 22197926.3

(51) Int. Cl. F21K 9/238; F21K 9/65; F21K 9/68; F21K 9/69; F21V 17/16

(52) U.S. Cl. CPC F21K 9/238; F21K 9/68; F21K 9/69; F21V 17/162; F21K 9/65

(57) ABSTRACT

A lighting arrangement (100), comprising: a printed circuit board, PCB (110), the PCB comprising a light emitting diode, LED light source (140), arranged to emit LED light (150), a reflector (120), a rod-shaped light guide element (130) extending along a principal axis, A, the light guide element comprising a first end (131), a second end (132) and a side surface (160) extending from the first end to the second end, wherein the light guide element is arranged between the PCB and the reflector, wherein the PCB is arranged at the first end and the reflector is arranged at the second end, and wherein the second end comprises a recess (1321) towards the first end and the reflector being arranged to be recessed at least partly into the recess, and at least one fastening arrangement (121, 133, 1328, 1201) arranged for releasable connection between the light guide element and the reflector.

### FIELD OF THE INVENTION

The present invention generally relates to lighting arrangements. In particular, the lighting arrangements comprise a releasably connectable reflector with optimized optical performance.

### BACKGROUND OF THE INVENTION

The area of illumination has seen a rapid development with the introduction of new technologies, such as light emitting diodes, LEDs. The area is under continuous transformation and continues to attract attention. Compared to traditional light sources such as incandescent lamps, fluorescent lamps, neon tube lamps, etc., arrangements or devices comprising LEDs provide numerous advantages such as an increased flexibility and control, a more compact design, and/or a reduced power consumption. In particular, traditional light sources are rapidly being replaced by LED-based lighting solutions.

Light guide systems and/or arrangements have been disclosed in prior art to provide light guiding and color mixing effects in lamps. However, current light guide-based lamps have several drawbacks, including e.g. complex and/or cumbersome assemblies of the lamps, and/or that the lamps suffer from optical losses, poor thermal management, disentanglement of components, etc.

Hence, it is an object of the present invention to provide an alternative lighting arrangement, which preferably obviates one or more of the above-described drawbacks. The present invention may also have an object to overcome or ameliorate at least one of the disadvantages of the lamps of the prior art, or to provide a useful alternative to these lamps.

### SUMMARY OF THE INVENTION

In the light of the above, it is of interest to provide alternative lighting arrangements in order to reduce the assembling complexity of the lighting arrangement, and to improve the reliability and light distribution of the lighting arrangement. These and other objects are achieved by providing a lighting arrangement having the features in the independent claim. Preferred embodiments are defined in the dependent claims.

Hence, according to an aspect of the present invention, there is provided a lighting arrangement. The lighting arrangement comprises a printed circuit board, PCB, wherein the PCB comprises a light emitting diode, LED light source, arranged to emit LED light, and a reflector. The lighting arrangement further comprises a rod-shaped light guide element extending along a principal axis, A, the light guide element comprises a first end, a second end and a side surface extending from the first end to the second end, wherein the light guide element is arranged between the PCB and the reflector, wherein the PCB is arranged at the first end and the reflector is arranged at the second end, and wherein the second end comprises a recess towards the first end and the reflector is arranged to be recessed at least partly into the recess. The lighting arrangement further comprises at least one fastening arrangement arranged for releasable connection between the light guide element and the reflector.

Thus, the present invention is based on the idea of providing a lighting arrangement in which the light guide element and the reflector are releasably connected via one or more fastening arrangements. In other words, due to the features of the lighting arrangement, the complexity of the assembly and/or disassembly of the lighting arrangement is reduced.

By the term “light guide element”, it is here meant substantially any element, material, structure, or the like, which is arranged or configured to guide and/or reflect the light emitted from the LED light source during operation.

According to an embodiment of the present invention, the at least one fastening arrangement comprises a snap-locking fastening arrangement. The snap-locking fastening arrangement comprises a first snap-locking element arranged at the second end of the light guide element, and a second snap-locking element arranged on the reflector, the first and second snap-locking elements are matingly connectable. Due to this arrangement, the operation to connect the light guide element and the reflector is simplified, leading to an even further reduction of the complexity to assemble the lighting arrangement.

According to an embodiment of the present invention, one of (i) the first snap-locking element comprises a male snap-locking element and the second snap-locking element comprises a female snap-locking element, and (ii) the first snap-locking element comprises a female snap-locking element and the second snap-locking element comprises a male snap-locking element, is fulfilled. Hence, the first snap-locking element comprises a male snap-locking element and the second snap-locking element comprises a female snap-locking element or the first snap-locking element comprises a female snap-locking element and the second snap-locking element comprises a male snap-locking element.

According to an embodiment of the present invention, the first snap-locking element is arranged at a periphery of the side surface and the second snap-locking element is arranged at the top of the reflector. Due to this arrangement, the fastening arrangement has a minimal optical impact on the lighting arrangement, consequently leading to a uniform light distribution upon operation of the lighting arrangement.

According to an embodiment of the present invention, the at least one fastening arrangement comprises a press-fit fastening arrangement. The press-fit fastening arrangement comprises one of (i) a female connector arranged at the bottom of the recess and a male connector arranged at the bottom of the reflector, and (ii) a male connector arranged at the bottom of the recess and a female connector arranged at the bottom of the reflector, wherein the female and male connectors are matingly connectable. Due to this arrangement, the connection between the light guide element and the reflector is facilitated. For example, a user may conveniently push the male connector into the female connector, which significantly reduces the complexity of the assembly of the lighting arrangement.

According to an embodiment of the present invention, one of (i) the female connector arranged at the bottom of the recess is a cavity centrally arranged in the recess and the male connector arranged at the bottom of the reflector is a protrusion protruding centrally from the reflector, and (ii) the female connector arranged at the bottom of the reflector is a cavity centrally arranged in the reflector and the male connector arranged at the bottom of the recess is a protrusion protruding centrally from the recess, is fulfilled. Hence, the female connector arranged at the bottom of the recess is a cavity centrally arranged in the recess and the male connector arranged at the bottom of the reflector is a protrusion protruding centrally from the reflector, or the female connector arranged at the bottom of the reflector is a cavity centrally arranged in the reflector and the male connector arranged at the bottom of the recess is a protrusion protruding centrally from the recess. Due to this arrangement, the light guide element and the reflector have an accurate fixation and/or alignment at the bottom of the recess and the reflector. Furthermore, by arranging the male and female connectors centrally at the bottom, the optical impact of the fastening arrangement is further reduced. Consequently, the distribution of the light during operation of the lighting arrangement is improved.

According to an embodiment of the present invention, the protrusion is polygonal, wherein the maximum width, Wmax, of the protrusion is larger than the diameter, D, of the cavity and the minimum width, Wmin, of the protrusion is smaller than the diameter of the cavity. The present embodiment is advantageous in that the lighting arrangement provides an improved circulation or exchange of air. Furthermore, the fitting of the polygonal protrusion with the cavity enables an easy fixation and ensures space for deformation, leading to a stable press fit effect between the light guide element and the reflector.

According to an embodiment of the present invention, the reflector comprises three alignment arrangements configured to align the reflector into the recess. The present embodiment is advantageous in that the accuracy of the alignment and fixation of the reflector and the recess is improved.

According to an embodiment of the present invention, the reflector is conical.

According to an embodiment of the present invention, the conical reflector has an apex angle, θ, ranging from 50° to 90°. Due to this arrangement, the lighting arrangement is further advantageous in that it may provide a uniform light distribution upon operation.

According to an embodiment of the present invention, the lighting arrangement comprises an air gap arranged between an inner surface of the recess and the reflector. Due to this arrangement, the light uniformity is further improved.

According to an embodiment of the present invention, the recess comprises an apex and the air gap is tapered from the apex towards the second end of the recess. Hence, the recess is conical and comprises an apex, such that the air gap between the recess and the reflector becomes narrower from the apex towards the top of the recess. Due to this arrangement, different light distribution can be obtained through total internal reflection, TIR, and reflection, R, resulting in an improved light uniformity.

According to an embodiment of the present invention, at least part of the LED light is coupled into the light guide element at the first end as in-coupled light, the light guide element is configured to guide, based on total internal reflection, TIR, at least part of the in-coupled light as guided light to the second end, wherein the lighting arrangement is further configured to reflect at least part of the guided light such that the reflected part of the guided light is arranged to exit the lighting arrangement via TIR at an interface between the light guide element and the air gap. Due to this arrangement, the light uniformity is further improved.

According to an embodiment of the present invention, at least part of the bottom of the recess is flat.

According to an embodiment of the present invention, the lighting arrangement is further configured to reflect at least part of the guided light such that the reflected part of the guided light is arranged to exit the lighting arrangement at the periphery of the light guide element via reflection, R, at a reflective surface of the reflector. Due to this arrangement, the light uniformity is further improved.

It will be appreciated that the lighting arrangement of the present invention may be suitable for use in a number of lighting devices, luminaires, or the like. Thus, the lighting arrangement may be beneficial in substantially any area for illumination purposes.

According to an embodiment of the present invention, there is provided a LED lamp or luminaire comprising a lighting arrangement according to any one of the preceding embodiments. The LED lamp comprises an envelope at least partly enclosing the lighting arrangement, and a base wherein the base comprises a cap arranged to mechanically and electrically connect the lighting arrangement to a socket of a luminaire. The present embodiment is advantageous in that the luminaire, comprising the lighting arrangement provides light which has desirable properties such as e.g. optimal light distribution.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1 schematically shows a sectional overview of a portion of a lighting arrangement according to an exemplifying embodiment of the present invention,

FIG. 2 schematically shows a sectional view of a portion of a lighting arrangement with guided light according to an exemplifying embodiment of the present invention,

FIGS. 3a, 3b and 3c schematically show sectional views of a portion of a lighting arrangement comprising alternative shapes of reflectors and recesses according to exemplifying embodiments of the present invention,

FIG. 4 schematically shows an overview of a fixed reflector with fastening arrangements according to a first exemplifying embodiment of the present invention,

FIG. 5 schematically shows a detailed view of a reflector fixed on a light guide element with fastening arrangements according to the first exemplifying embodiment of the present invention,

FIG. 6 schematically shows a bottom view of a lighting arrangement with fastening arrangements according to the first exemplifying embodiments of the present invention,

FIG. 7 schematically shows a top view of a lighting arrangement with fastening arrangements according to the first exemplifying embodiments of the present invention,

FIG. 8 schematically shows a detailed sectional view of a portion of a lighting arrangement with an air gap according to the first exemplifying embodiments of the present invention,

FIG. 9 schematically shows an overview of a fixed reflector with fastening arrangements according to a second exemplifying embodiment of the present invention,

FIG. 10 schematically shows a detailed sectional view of connected reflector and light guide element according to the second exemplifying embodiment of the present invention,

FIG. 11 schematically shows another detailed sectional view of connected reflector and light guide element according to the second exemplifying embodiment of the present invention,

FIG. 12 schematically shows another detailed view of the bottoms of the recess and the reflector according to the second exemplifying embodiment of the present invention,

FIG. 13 schematically shows a view of the reflector with align arrangements according to some exemplifying embodiments of the present invention, and

FIG. 14 schematically shows a view of a LED lamp comprising a lighting arrangement according to an exemplifying embodiment of the present invention.

### DETAILED DESCRIPTION

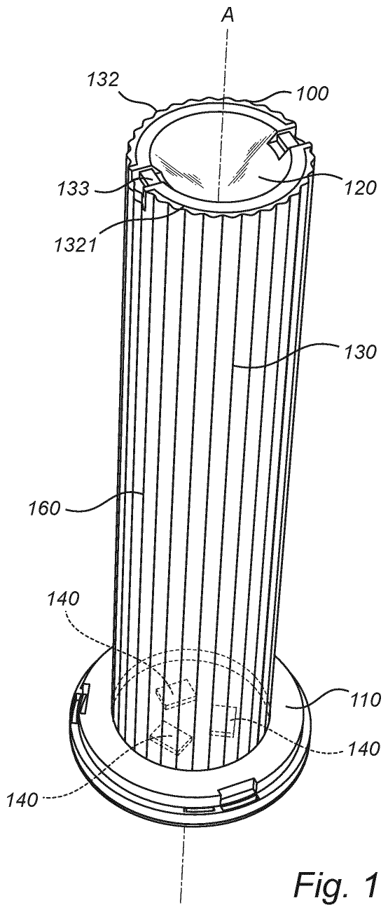

FIG. 1 schematically shows a sectional overview of a portion of a lighting arrangement 100 according to an exemplifying embodiment of the present invention. The lighting arrangement 100 comprises a PCB 110, the PCB 110 comprising a LED light source 140 arranged to emit LED light 150. It will be appreciated that the PCB 110 may comprise substantially any number of LEDs of the LED light source 140. For example, the LEDs of the LED light source 140 may be aligned in a horizontal array. According to one alternative example, the LED light source 140 may comprise at least one first LED arranged to emit white light, wherein the white light means light having a wavelength range of 400-700 nm. According to another alternative example, the LED light source 140 may comprise at least one second LED arranged to emit red light, wherein red light means light having a wavelength range of 450-495 nm. According to another alternative example, the LED light source 140 may comprise at least one third LED arranged to emit at least one of green and yellow light, wherein the green light means light having a wavelength range of 495-570 nm and the yellow light means light having a wavelength range of 570-590 nm. According to another alternative example, the LED light source 140 may comprise at least one fourth LED arranged to emit blue light, wherein blue light means light having a wavelength range of 620-750 nm. According to another alternative example, the white light may have a correlated color temperature in a range from 2000 to 8000 K. The white light may have a color rendering index of at least 80, especially at least 85. At least one of these LEDs emitting different light may form the LED light source 140 or be combined together to form the LED light source 140.

The lighting arrangement 100 further comprises a reflector 120 arranged to reflect at least part of the light incident on it. The lighting arrangement 100 further comprises a rod-shaped light guide element 130 configured to guide light emitted from the LED light source 140. The rod-shaped light guide element 130 may be either solid or hollow. The rod-shaped light guide element 130 is preferably transparent and may preferably have a round cross-section, CS. In some embodiments, the rod-shaped light guide element 130 may be made from polymer, such as polymethyl methacrylate, PMMA, polycarbonates, PC and/or polyethylene terephthalate, PET. To further improve the effect of color mixing, in some embodiments, a length, L, of the light guide element 130 along the principal axis, A, and a diameter, D, of the cross section, CS, may have a ratio, R, which fulfills R=L/D≥4. The length, L, may be defined according to the specific application situations. In some alternative examples, the length, L, is in a range from 3 to 12 cm. The diameter, D, of the cross section, CS, may also be defined according to the specific application situations. In some alternative examples, the diameter, D, is in a arrange from 0.3 to 3 cm.

The light guide element 130 extends along a principal axis, A, and comprises a first end 131, a second end 132 and a side surface 160 extending from the first end 131 to the second end 132. In some embodiments, the side surface 160 may comprise optical features and/or a surface structure. The light guide element 130 is arranged between the PCB 110 and the reflector 120, wherein the PCB 110 is arranged at the first end 131 and the reflector 120 is arranged at the second end 132. The second end 132 comprises a recess 1321 towards the first end 131 and the reflector 120 is arranged to be recessed at least partly into the recess 1321. According to some embodiments, 95% of the reflector 120 is arranged to be recessed in the recess 1321. At least one fastening arrangement 121, 133, 1328 and 1201 is arranged for releasable connection between the light guide element 130 and the reflector 120.

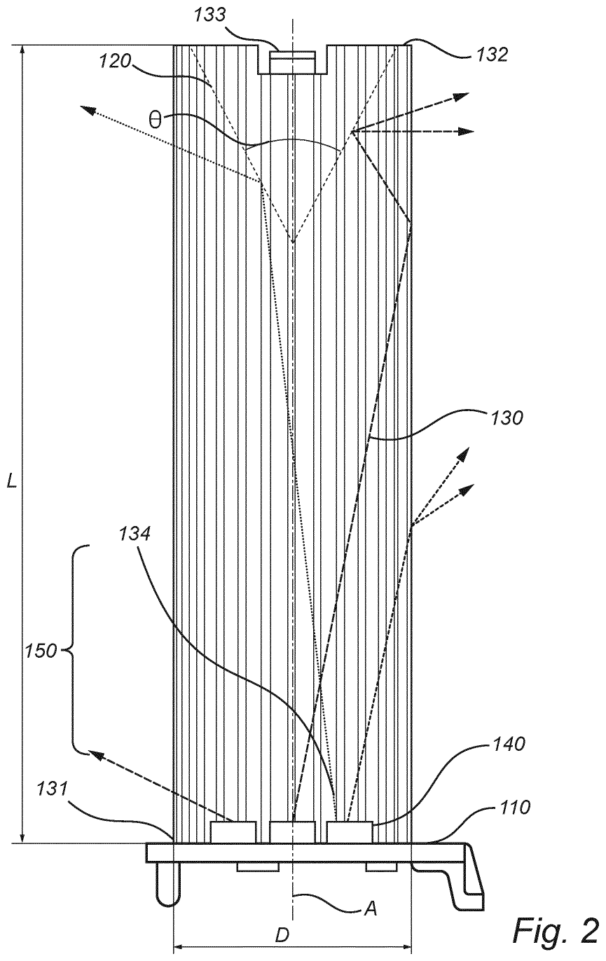

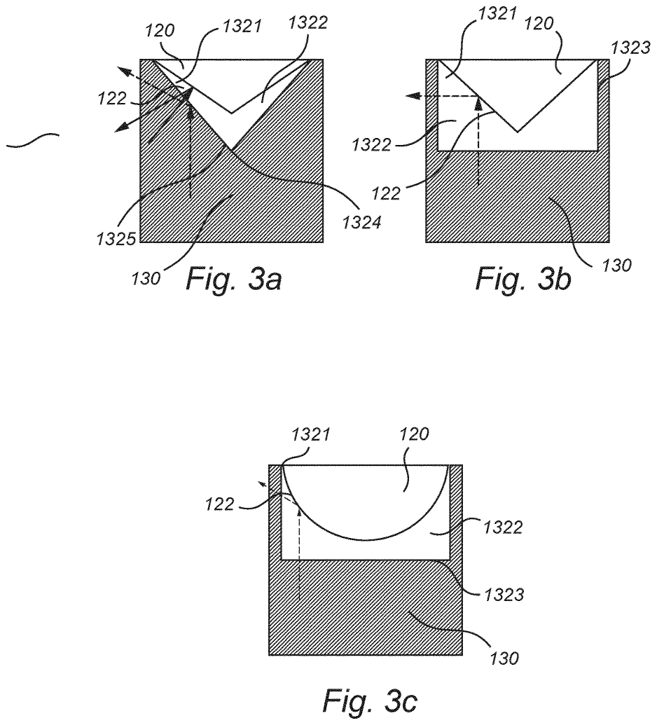

FIG. 2 schematically shows a sectional view of a portion of a lighting arrangement with guided light according to an exemplifying embodiment of the present invention. To explain the structure of the lighting arrangement in detail, the following content is elaborated in combination with FIGS. 3a, 3b and 3c schematically showing sectional views of a portion of a lighting arrangement comprising alternative shapes of reflectors and recesses according to exemplifying embodiments of the present invention, and the references provided therein. According to some embodiments, when the lighting arrangement 100 is in operation, at least part of the LED light 150 is coupled into the light guide element 130 at the first end 131 as in-coupled light and the light guide element 130 is configured to guide, based on TIR, at least part of the in-coupled light as guided light 134 to the second end 132. According to some embodiments, the reflector 120 may be conical as shown in FIGS. 3a and 3b. According to some other embodiments, the reflector 120 may be hemispherical as shown in FIG. 3c. According to some other embodiments, the reflector 120 may have other shapes for specific purposes. In some embodiments, the recess 1321 may have an apex 1324 as shown in FIG. 3a. In some other embodiments, at least part of the recess 1321 is flat. In some other embodiments, in order to obtain more reflections, the recess 1321 may have a flat bottom as shown in FIGS. 3b and 3c. According to some other examples, the conical reflector 120 may have an apex angle, θ, as shown in FIG. 2, in a range from 50° to 90°, preferably in a range from 60° to 80°, and more preferably 70°-74°. According to some embodiments, the reflector 120 may be slightly larger, equal to, or a bit smaller in width than the light guide 130 such that different light distributions may be obtained. According to some embodiments, the reflector 120 is slightly smaller in diameter than the light guide, e.g. 5-30% smaller, some guided light 134 is not blocked and can exit the light guide element 130 in a direction substantially parallel to the principal axis, A.

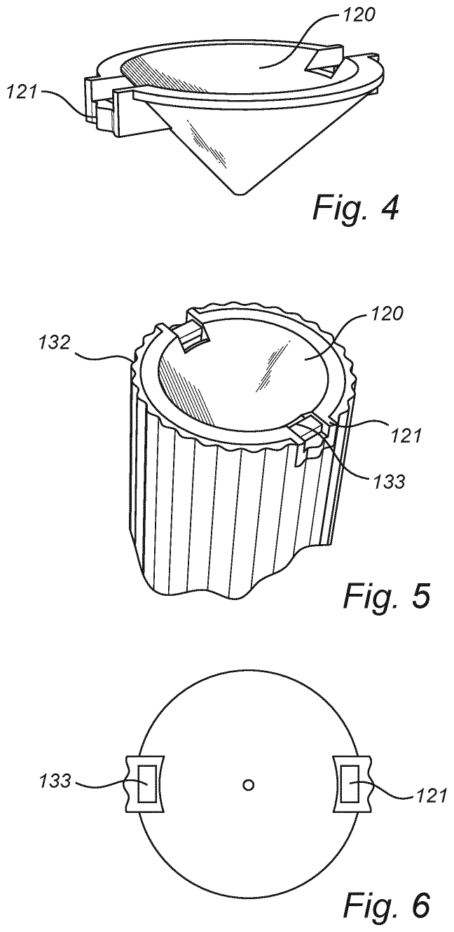

FIGS. 4-8 schematically show views of the lighting arrangement with fastening arrangements according a first exemplifying embodiment of the present invention.

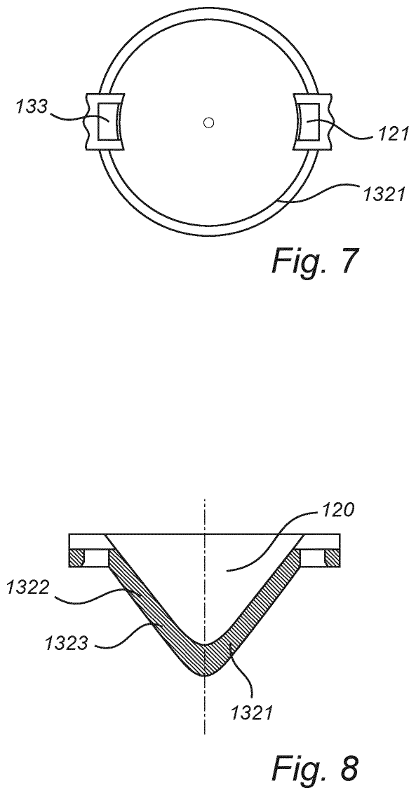

FIG. 4 schematically shows an overview of a fixed reflector with fastening arrangements according to a first exemplifying embodiment of the present invention, FIG. 5 schematically shows a detailed view of a reflector fixed on a light guide element with fastening arrangements according to the first exemplifying embodiment of the present invention, and FIGS. 6 and 7 show a bottom view and a top view of the lighting arrangement with fastening arrangements according to the first exemplifying embodiments of the present invention, respectively. According to some embodiments, the at least one fastening arrangement 121, 133 comprises a snap-locking fastening arrangement 121, 133. The snap-locking fastening arrangement 121, 133 comprises a first snap-locking element 133 arranged at the second end of the light guide element 130, and a second snap-locking element 121 arranged on the reflector 120, wherein the first snap-locking element 133 and the second snap-locking elements 121 are matingly connectable. Further, according to some embodiments, the first snap-locking element 133 comprises a male snap-locking element, and the second snap-locking element 121 comprises a female snap-locking element. According to some alternative embodiments, the first snap-locking element 133 comprises a female snap-locking element and the second snap-locking element 121 comprises a male snap-locking element. The first snap-locking element 133 is a click on the light guide element 130, and the second snap-locking element 121 is a recess or a hole on the reflector 120, when the reflector 120 is fixed on the light guide element 130, the click is clicked into the recess or hole of the reflector 120. According to some other embodiments, the first snap-locking element 133 is a recess or a hole on the light guide element 130, and the second snap-locking element 121 is a click on the reflector 120, when the reflector 120 is fixed on the light guide element 130, the click is clicked into the recess or hole of light guide element 130. FIGS. 6 and 7 further show a bottom view and a top view, respectively, of the lighting arrangement 100.

According to some other embodiments, the fastening arrangement 121, 133 may comprise hermaphroditic connectors. In some embodiments, the hermaphroditic connectors are hermaphroditic push-pull connectors.

By having the above fastening arrangement 121, 133, the reflector 120 is releasably connected to the light guide element 130, which reduces the complexity of assembly or disassembly of the lighting arrangement, and at the same time avoids a disentanglement of the lighting arrangement components, e.g. in case a lamp comprising the lighting arrangement falls. Furthermore, it enables possible replacement of different reflectors 120 fixed onto the light guide element 130.

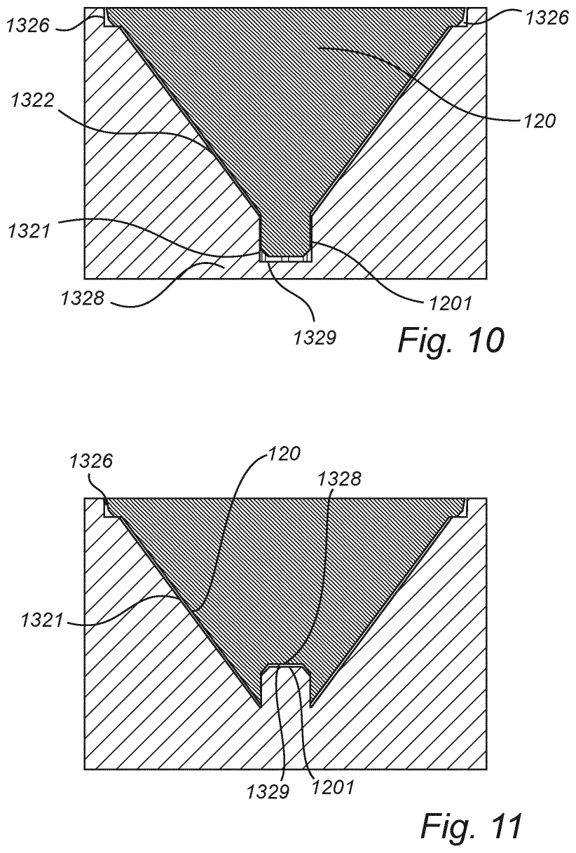

FIG. 8 schematically shows a detailed sectional view of a portion of a lighting arrangement with an air gap according to some exemplifying embodiments of the present invention. According to some embodiment, the lighting arrangement 100 further comprises an air gap 1322 between an inner surface 1323 of the recess 1321 and the reflector 120. The formation of the air gap 1322 will be explained in combination with details partly shown in FIG. 10. According to some embodiments, a support 1326 may be provided at the top of the recess 1321 to support part of the reflector 120 to ensure the air gap 1322 is formed between the reflector 120 and the recess 1321 of the light guide element 130.

To further explain the reflection of the guided light 134, the following content is elaborated in combination with FIGS. 2 and 3a-3c. According to some embodiments, the lighting arrangement 100 is configured to reflect at least part of the guided light 134 such that the reflected part of the guided light 134 is arranged to exit the lighting arrangement 100 via TIR at an interface 1325 between the light guide element 130 and the air gap 1322. According to some other embodiments, the lighting arrangement 100 is further configured to reflect at least part of the guided light 134 such that the reflected part of the guided light 134 is arranged to exit the lighting arrangement 100 at the periphery of the light guide element 130 via reflection, R, at a reflective surface 122 of the reflector, which is shown in FIG. 3a. According to some embodiments, to obtain different light distribution based on TIR and R, the reflector 120 may be arranged to be conical and has an apex 1324, the air gap 1322 between the reflector 120 and the light guide element 130 is tapered from the apex 1324 towards the top of the recess 1321, in other words, the air gap 1322 between the reflector 120 and the light guide element 130 becomes narrower from the apex 1324 towards the top of the recess 1321, which is shown in FIG. 3a. According to other embodiments, when the recess 1321 has a flat bottom, there is no TIR at the interface 1325 between the light guide element 130 and the air gap 1322. The reflector 120 is thereby arranged to only reflect at least part of the guided light 134 incident on the reflector 120 such that the reflected light is arranged to exit the lighting arrangement 100 at the periphery of the light guide element 130 via reflection, R, at a reflective surface 122 of the reflector, which is shown in FIGS. 3b and 3c. According to some embodiments, the reflectivity of the reflector 120 is at least 80%, preferably at least 85%, more preferably at least 88%, most preferably at least 90%. According to some embodiments, the reflection is preferably diffuse reflection.

Because of the above disclosed specific reflections using the air gap 1322 and the reflected surface 122, an optimal light distribution is obtained.

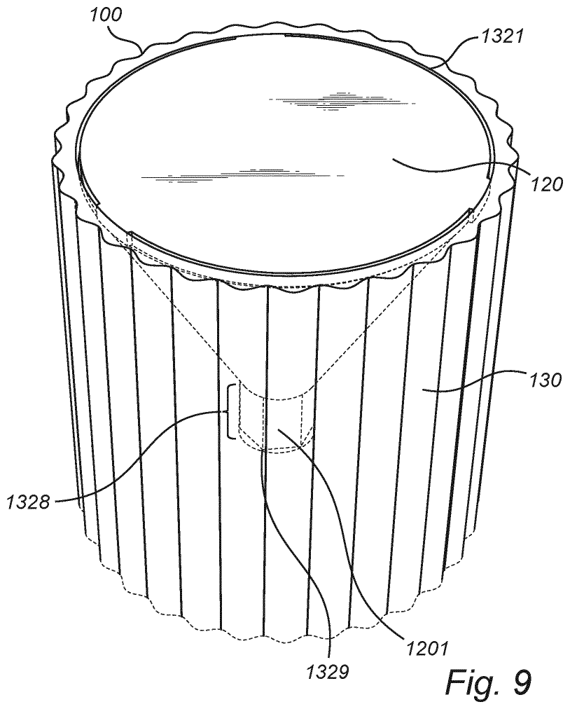

FIGS. 9-12 schematically show views of the lighting arrangement with fastening arrangements according to a second exemplifying embodiment of the present invention.

FIG. 9 schematically shows an overview of a fixed reflector with fastening arrangements according to a second exemplifying embodiment of the present invention, and FIG. 10 schematically shows a detailed sectional view of connected reflector and light guide element according to the second exemplifying embodiment of the present invention. FIG. 11 schematically shows another detailed view of the bottoms of the recess and the reflector according to the second exemplifying embodiment of the present invention. According to some embodiments, the at least one fastening arrangement 1328, 1201 comprises a press-fit fastening arrangement. The press-fit fastening arrangement comprises a female connector 1328 arranged at the bottom of the recess 1321 and a male connector 1201 arranged at the bottom of the reflector 120, wherein the female and male connectors 1328, 1201 are matingly connectable. According to some embodiments, the female connector 1328 is a cavity in the recess 1321 and the male connector 1201 is a protrusion from the reflector 120, which is shown in FIG. 10. According to some other alternative embodiments, the press-fit fastening arrangement 1328, 1201 comprises a female connector 1328 arranged at the bottom of the reflector 120 and a male connector 1201 arranged at the bottom of the recess 1321, wherein the female and male connectors 1328, 1201 are matingly connectable. According to some embodiments, the female connector 1328 is a cavity in the reflector 120 and the male connector 1201 is a protrusion from the recess 1321, which is shown in FIG. 11. According to some embodiments, both the cavity and the protrusion are centrally arranged in the female 1328 and male connectors 1201. With this arrangement, the fastening arrangement 1328, 1201 has minimal optical impact on the lighting arrangement.

According to some other embodiments, a second gap 1329 is created between the reflector 120 and the light guide element 130 at the bottom through the connection between the male 1201 and female connectors 1328. According to some embodiments, the second gap 1329 between the male 1201 and female connectors 1328 is larger than other gaps at the bottom part. With this arrangement, a stable press-fit is obtained between the reflector 120 and the light guide element 130.

With the above arrangements, the reflector 120 is releasably connected to the light guide element 130, which reduces the complexity of assemble or disassemble and at the same time avoids the components disentangle when a lamp comprising the lighting arrangement falls and enables possible replacement of the different reflectors 120 to the light guide element 130.

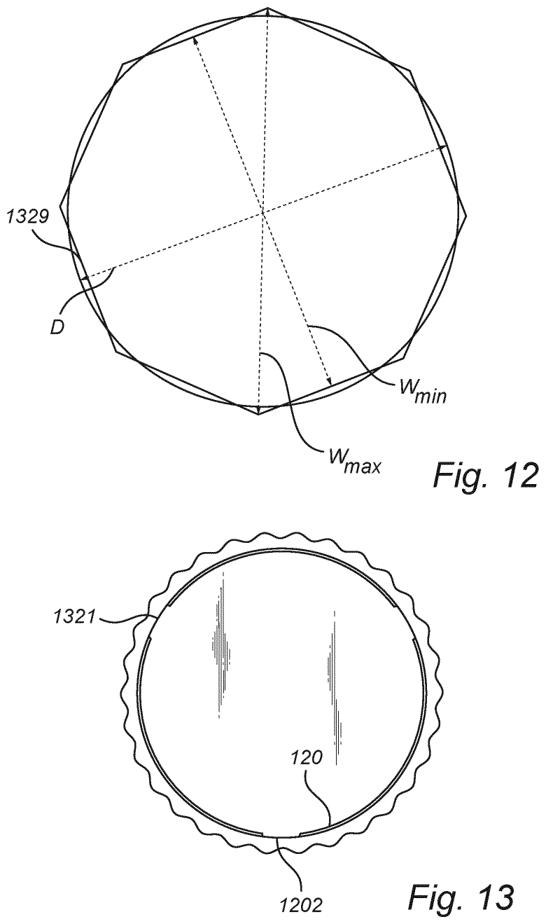

FIG. 12 schematically shows a detailed view of the bottom of the recess and the reflector according to an exemplifying embodiment of the present invention. According to some embodiments, the male connector 1328 may be arranged to be polygonal. In some preferred embodiments, the polygonal male connector 1328 may have at least 5 sides. According to some embodiments, the minimum width, Wmin, of the polygonal male connector 1201 is smaller than the diameter, D, of the female connector 1328. According to some embodiments, the maximum width, Wmax, of the polygonal male connector 1201 is larger than the diameter, D, of the female connector 1328. These arrangements improve the exchange of air and ensure space for deformation of structure such that the stable press-fit is further improved between the reflector 120 and the light guide element 130.

FIG. 13 schematically shows a view of the reflector with alignment arrangements according to some exemplifying embodiments of the present invention. According to some embodiments, the reflector 120 may have at least one alignment arrangement 1202. According to some embodiments, the at least one alignment arrangement 1202 may be arranged at the top of the reflector 120, ensuring accurate fixation and alignment of the reflector 120 and the light guide element 130 at the top of the recess 1321. In some preferred embodiments, there are 3 alignment arrangements 1202 which improves the alignment accuracy at the top of the recess 1321. In some preferred embodiments, the reflector can be fixed by aligning with the alignment arrangements 1302 and only being pushed into the recess 1321, this ensures no optical contact is made between the reflector 120 and the light guide element 130, thus the air gap 1322 between the inner surface of the light guide element 130 and the reflector 120 is created.

The embodiments described according to the first embodiment shown in FIGS. 4-8 and corresponding description may be combined with the embodiments described according to the second embodiment shown in FIG. 9-13 and corresponding description.

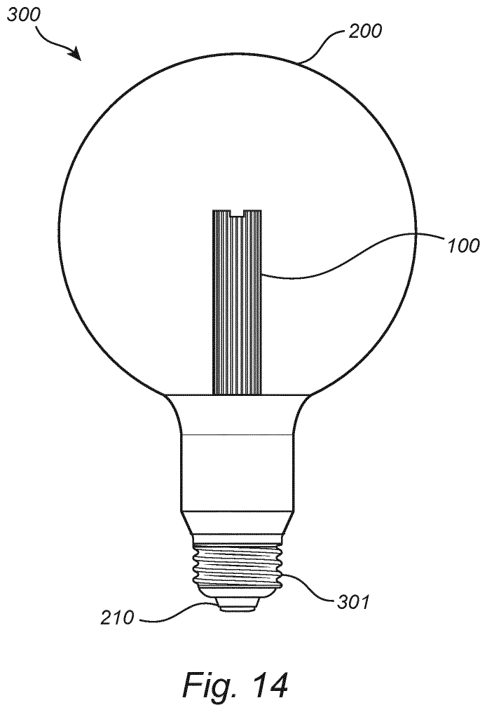

FIG. 14 schematically shows a view of a LED lamp 300 comprising a lighting arrangement 100 according to an exemplifying embodiment of the present invention. According to the example of FIG. 14, the LED lamp 300 comprises an envelope 200 at least partly enclosing the lighting arrangement according to an exemplifying embodiment of the present invention, and a base 301 wherein the base comprises a cap 210 arranged to mechanically and electrically connect the lighting arrangement to a socket of a luminaire. According to some embodiments, the lamp 300 may further comprise a controller for controlling the LEDs emitting different colours of light specifically. According to some other embodiments, the lamp 300 may further comprise an antenna for wireless communication with external devices, such as the controller.

According to some other embodiments, there is provided a luminaire. The luminaire comprises an envelope at least partly enclosing the lighting arrangement according to any exemplifying embodiment of the present invention.

The person skilled in the art realizes that the present invention by no means is limited to the preferred embodiments described above. On the contrary, many modifications and variations are possible within the scope of the appended claims. For example, one or more of the components of the lighting arrangement 100, such as the light guide element 130, the reflector 120, etc., may have different shapes, dimensions and/or sizes than those depicted/described.

1. A lighting arrangement, comprising:
a printed circuit board, PCB, the PCB comprising a light emitting diode, LED light source, arranged to emit LED light,
a reflector,
a rod-shaped light guide element extending along a principal axis, A, the light guide element comprising a first end, a second end and a side surface extending from the first end to the second end, wherein the light guide element is arranged between the PCB and the reflector, wherein the PCB is arranged at the first end and the reflector is arranged at the second end, and wherein the second end comprises a recess towards the first end and the reflector being arranged to be recessed at least partly into the recess, and
at least one fastening arrangement arranged for releasable connection between the light guide element and the reflector
wherein the at least one fastening arrangement comprises a press-fit fastening arrangement comprising one of
(i) a female connector arranged at the bottom of the recess and a male connector arranged at the bottom of the reflector, the female connector is a cavity centrally arranged in the recess and the male connector is a protrusion protruding centrally from the reflector and
(ii) a male connector arranged at the bottom of the recess and a female connector arranged at the bottom of the reflector, the male connector is a protrusion protruding centrally from the recess and the female connector is a cavity centrally arranged in the reflector
wherein the female and male connectors are matingly connectable, and
wherein the protrusion is polygonal, wherein the maximum width, Wmax, of the protrusion is larger than the diameter, D, of the cavity and the minimum width, Wmin, of the protrusion is smaller than the diameter of the cavity, and wherein at least part of the bottom of the recess is flat.

2. The lighting arrangement according to claim 1, wherein the at least one fastening arrangement comprises a snap-locking fastening arrangement comprising:
a first snap-locking element arranged at the second end of the light guide element, and
a second snap-locking element arranged on the reflector,
wherein the first and second snap-locking elements are matingly connectable.

3. The lighting arrangement according to claim 2, wherein one of
(i) the first snap-locking element comprises a male snap-locking element and the second snap-locking element comprises a female snap-locking element, and
(ii) the first snap-locking element comprises a female snap-locking element and the second snap-locking element comprises a male snap-locking element, is fulfilled.

4. The lighting arrangement according to claim 2, wherein the first snap-locking element is arranged at a periphery of the side surface and the second snap-locking element is arranged at the top of the reflector.

5. The lighting arrangement according to claim 1, wherein the reflector comprises three alignment arrangements configured to align the reflector into the recess.

6. The lighting arrangement according to claim 1, wherein the reflector is conical with an apex angle, θ, ranging from 50° to 90°.

7. The lighting arrangement according to claim 1, further comprising an air gap arranged between an inner surface of the recess and the reflector.

8. The lighting arrangement according to claim 7, wherein the recess comprises an apex and the air gap is tapered from the apex towards the top of the recess.

9. The lighting arrangement according to claim 7, wherein at least part of the LED light is coupled into the light guide element at the first end as in-coupled light, wherein the light guide element is configured to guide, based on total internal reflection, TIR, at least part of the in-coupled light as guided light to the second end, wherein the lighting arrangement is further configured to reflect at least part of the guided light such that the reflected part of the guided light is arranged to exit the lighting arrangement via TIR at an interface between the light guide element and the air gap.

10. (canceled)

11. The lighting arrangement according to claim 9, wherein the lighting arrangement is further configured to reflect at least part of the guided light such that the reflected part of the guided light is arranged to exit the lighting arrangement at the periphery of the light guide element via reflection, R, at a reflective surface of the reflector.

12. A LED lamp comprising:
a lighting arrangement according to claim 1,
an envelope at least partly enclosing the lighting arrangement, and
a base wherein the base comprises a cap arranged to mechanically and electrically connect the lighting arrangement to a socket of a luminaire.
